(19) United States
(12) Patent Application Publication
(10) Pub. No.: US 2010/0126890 A1
(43) Pub. Date: May 27, 2010

(54) STORAGE CONTAINER FOR MULTIPLE DATA STORAGE MEDIA

(76) Inventor: Agjah Libohova, Westbury, NY (US)

Correspondence Address: OSTROLENK FABER GERB & SOFFEN, 1180 AVENUE OF THE AMERICAS, NEW YORK, NY, 100368403, US

(21) Appl. No.: 12/497,454

(22) Filed: Jul. 2, 2009

Related U.S. Application Data
(60) Provisional application No. 61/105,409, filed on Oct. 14, 2008.

(51) Int. Cl. G11B 33/04; B65D 1/34

(52) U.S. Cl. 206/307; 206/557

(57) ABSTRACT

A container for storing data storage media in accordance with an embodiment of the present application includes a front cover, a rear cover and a plurality of removable trays operable to support data storage media, wherein each removable tray is rotatably connected to at least one other removable tray, and the plurality of removable trays is rotatably connected to at least one of the front cover and the rear cover such that the data storage media stored on the plurality of removable trays is accessible based on rotation of at least one removable tray.

### CROSS-REFERENCE TO RELATED APPLICATIONS

The present application claims the benefit of and priority to U.S. Provisional Patent Application Ser. No. 61/105,409 filed Oct. 14, 2008 entitled STORAGE CONTAINER FOR MULTIPLE DATA STORAGE MEDIA, the entire contents of which are hereby incorporated by reference herein.

### BACKGROUND

1. Field of the Disclosure

The present disclosure relates to an improved container for storing multiple data storage media. In particular, the present application relates to a container that is adapted to securely house a plurality of trays on which media such as audio books may be stored. The container is preferably adaptable such that the number of trays stored therein can be varied.

2. Related Art

It is becoming increasing popular for people to view or listen to their entertainment content on prerecorded video or audio data storage media, such as optical discs. Indeed, it is common for people to purchase a whole series of programs or movies together, or to purchase multiple data storage media with related content, for example, audio books. Such audio books are becoming increasingly popular. As a result, there is a need for storage containers that allow for the storage of a large number of data storage media.

While there are many such containers available on the market, these containers all have limited storage capacity. That is, they are manufactured with a finite capacity and expansion of this capacity is difficult, if not impossible. There is no container that provides a modular design that allows for easy expansion. Thus, a user must know in advance how much storage capacity they need and then order the container to that standard. This is inconvenient.

Accordingly, it would be beneficial to provide a storage container for data storage media that avoids these problems.

### SUMMARY

It is an object of the present application to provide a container that distinguishes media such as audio-books from other forms of media and addresses the need for quick and easy access and storage for multiple discs.

It is also an object of the present application to provide a modular container that allows for easy expansion.

A container for storing data storage media in accordance with an embodiment of the present application includes a front cover, a rear cover and a plurality of removable trays operable to support data storage media, each removable tray being rotatably connected to at least one other removable tray and the plurality of removable trays being rotatably connected to at least one of the front cover and the rear cover such that the data storage media stored on the plurality of removable trays is accessible based on rotation of at least one removable tray.

A tray for storing data recording media in accordance with an embodiment of the present application includes a first receptacle positioned on a first side of the tray and operable to receive data storage media, a rib extending inward from an inner edge of the tray, an elongated protrusion extending substantially parallel to the inner edge of the tray and a slot formed on the inner portion of the tray and structured to accommodate an adjacent elongated protrusion of an adjacent tray such that the tray and the adjacent tray are rotatable relative to each other.

A container for storing data storage media in accordance with an embodiment of the present application includes a front cover, a rear cover, a spine operable to rotatably connect the front cover and the rear cover such that the front cover and rear cover are operable to rotate between an open position and a closed position and a plurality of removable trays operable to support data storage media, the plurality of removable trays positioned in an interior of the container within the front cover, rear cover and spine when the front cover and rear cover are in the closed position. Each tray of the plurality of trays further includes a first receptacle positioned on a first side of the tray and operable to receive data storage media, an elongated protrusion extending substantially parallel to the inner edge of the removable tray and a slot formed on the inner portion of the removable tray and structured to accommodate an adjacent elongated protrusion of an adjacent removable tray such that the removable tray and the adjacent removable tray are rotatable relative to each other.

A container for storing data storage media in accordance with an embodiment of the present application includes a front cover, a rear cover, a spine operable to rotatably connect the front cover and the rear cover such that the front cover and rear cover are operable to rotate between an open position and a closed position and a cartridge operable to support data storage media, wherein the cartridge is rotatably mounted within the container.

### BRIEF DESCRIPTION OF THE DRAWINGS

FIG. 1 is an illustration of a storage container in accordance with an embodiment of the present application;

FIG. 2 is a more detailed view of a portion of the container of FIG. 1;

FIG. 3 is a more detailed side view of the container of FIG. 1;

FIG. 4 is an illustration of the container of FIG. 1 in a closed condition;

FIG. 5 is a more detailed view of the container in FIG. 4;

FIG. 6 is an illustration of the container of FIG. 1 in an open condition illustrating rotation of one of the trays provided therein;

FIG. 7 is a more detailed view of a portion of the container in FIG. 6

FIG. 8 is a detailed view of the container in FIG. 7 where the tray has been rotated 180 degrees;

FIG. 9 is a detailed view of the container in FIG. 8 where a second tray is being rotated in the container;

FIG. 10 is a detailed view of an outer side of a tray of the container of FIG. 1;

FIG. 11 is a cross section of FIG. 10;

FIG. 12 is a cross section view illustrating how the trays in the container lock together;

FIG. 13 is a perspective view of a single tray of the container of the present application;

FIG. 14 is a perspective view of a front cover of the container of FIG. 1;

FIG. 14A is a perspective view of a front cover of the container of FIG. 1 in accordance with another embodiment of the present application;

FIG. 15 is a perspective view of the rear cover of the container of FIG. 1;

FIG. 16 is an illustration of a container in accordance with an embodiment of the present application in which the front and rear covers are made of cardboard;

FIG. 17 is an illustration of a container in accordance with an embodiment of the present application in which the front and rear covers are covered with cardboard;

FIG. 18 is an illustration of an outer surface of a rear cover of a container in accordance with an embodiment of the present application; and

FIG. 19 is an illustration of a cardboard cover that may be attached to the rear cover illustrated in FIG. 18;

FIG. 20 is an illustration of an alternative embodiment of a tray in accordance with an embodiment of the present application;

FIG. 20A is an illustration of a portion of an opposite side of the tray of FIG. 20;

FIG. 21 is an illustration of two trays similar to that illustrated in FIG. 20 rotatably joined together;

FIG. 22 is an illustration of three trays similar to that illustrated in FIG. 20 rotatably joined together;

FIG. 23 is an illustration of two trays similar to that illustrated in FIG. 20 rotated with respect to each other;

FIG. 24 is an illustrated of two trays similar to those illustrated in FIG. 20 positioned between a front and rear cover;

FIG. 24A illustrates a more detailed view of two trays snapped together between the front and rear cover;

FIG. 24B illustrates two trays snapped together with the front an drear cover;

FIG. 24C illustrates another detailed view of two trays snapped together between the front and rear cover;

FIG. 25 is an illustration of a tray in accordance with an embodiment of the present application rotatably connected to a cover;

FIG. 26 is an illustration of a conventional container including a tray in accordance with an embodiment of the present application;

FIG. 27 is a more detailed illustration of a connection between the tray and a cover of the conventional container in FIG. 26;

FIG. 28 is an illustration of a conventional container including multiple trays in accordance with an embodiment of the present application;

FIG. 29 is an illustration of a conventional container including a cartridge in accordance with an embodiment of the present application;

FIG. 30 is a more detailed illustration of a bracket for rotatably mounting the cartridge in the container of FIG. 29;

FIG. 31 illustrates the cartridge of FIG. 30 positioned in the container with the bracket removed;

FIG. 32 illustrates an alternative embodiment of the cartridge of FIG. 30; and

FIG. 33 illustrated another view of the cartridge of FIG. 32.

Other features and advantages of the present invention will become apparent from the following description of the invention, which refers to the accompanying drawings.

### DESCRIPTION OF THE EMBODIMENTS

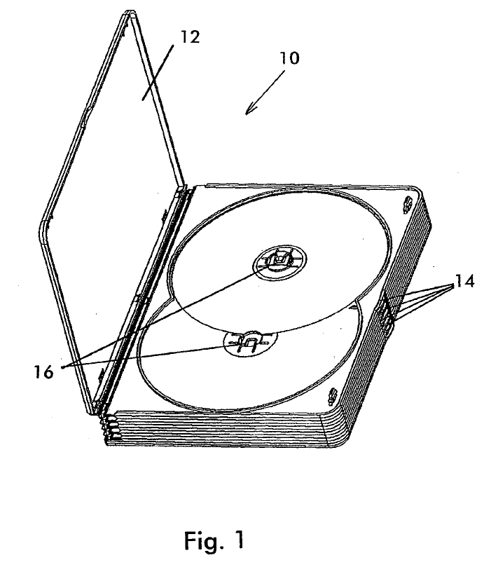

A container 10 in accordance with an embodiment of the present application is illustrated generally in FIG. 1. Preferably, the container 10 is used as a package for audio books, although it should be realized by those skilled in the art that the container 10 could be used for any type of media.

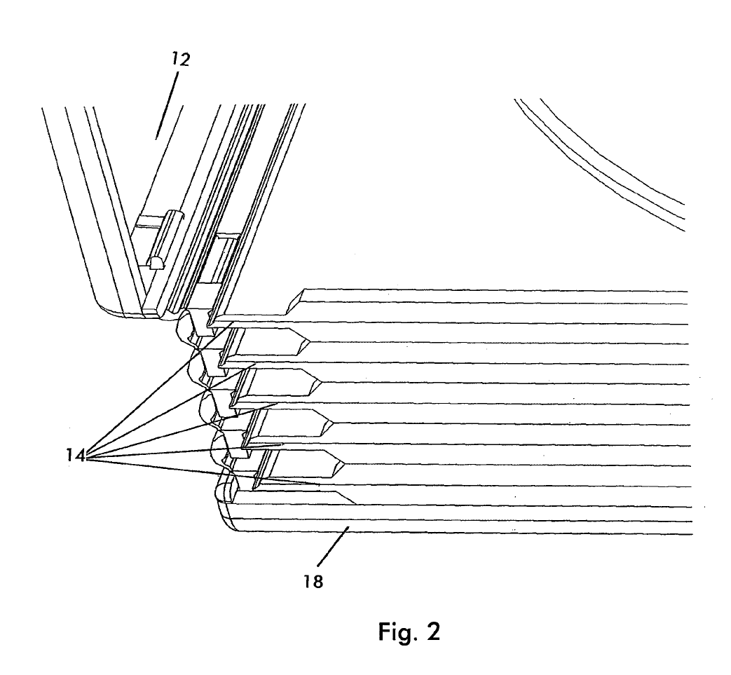

Preferably, the container 10 has a structure that is somewhat similar to that of a book. The container 10 preferably includes a cover 12 and a plurality of trays 14 that are stored in the container and include at least one receptacle 16 for holding data storage media, for example, an optical disc. In a preferred embodiment, each tray 14 includes one receptacle 16 on each side thereof. As can be seen in the more detailed view provided in FIG. 2, the container 10 also includes a rear cover 18 as well, with a plurality of trays 14 positioned between the cover 12 and the rear cover 18 like the pages of a book. In one embodiment, the trays 14 and the covers 12, 18 are made of a plastic material.

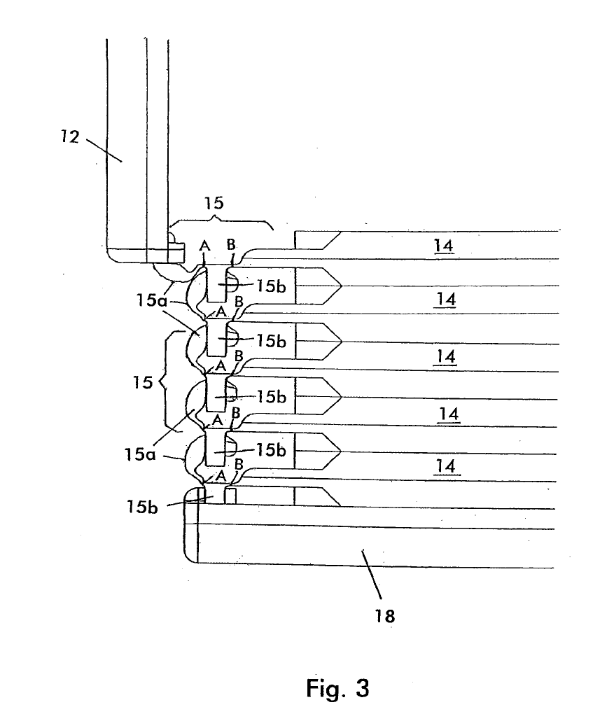

The trays 14 are preferably stackable one on top of the other as illustrated in FIG. 3, for example. Each tray 14 preferably includes a tray spine 15 that is used to connect it to one of the covers 12, 18 or to one of the other trays 14. The tray spine 15 preferably includes a curved tab 15a extending from an inner end thereof that is used to connect the tray to the cover 12, or to another tray. The tab 15a is connected to a rib portion 15b of the tray spine 15. The rib portion 15b is in turn connected to the rest of the tray 14. The connection between the tab 15a and the rib 15b and between the rib 15b and the rest of the tray 14 is made via so-called living hinges A, B such that rotation is possible between the tab and the rib and the rib and the rest of the tray. That is, the two living hinges A, B provide two points of articulation in the tray spine 15. Living hinges are generally thin flexible hinges made from plastic that join two more rigid plastic parts together, allowing them to bend along the line of the hinge.

The top tray is preferably connected to the cover 12 via the tray spine 15. Specifically, as can be seen in FIG. 3, the tab 15a extends into an opening formed in the cover 12. The shape of the tab 15a is preferably provided such that it snaps into place in an opening in the cover 12. In this manner, the user can be sure that connection has taken place.

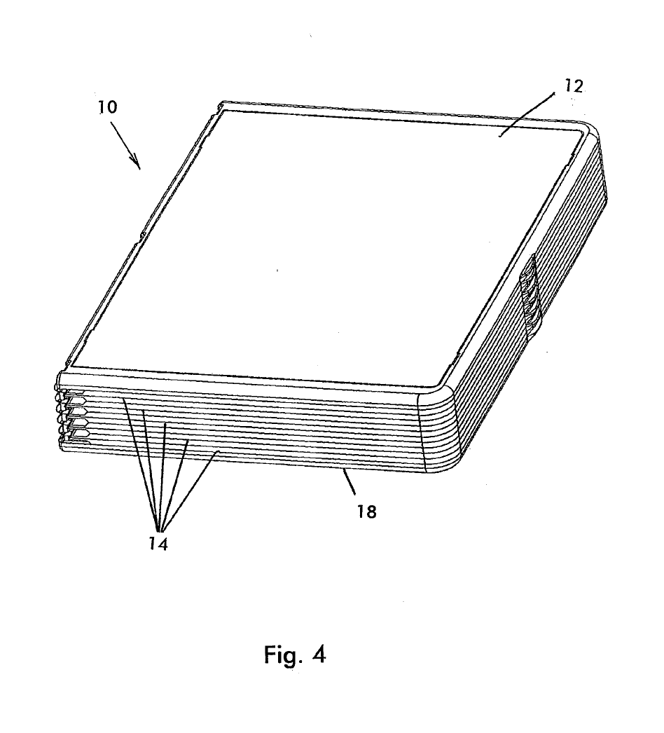

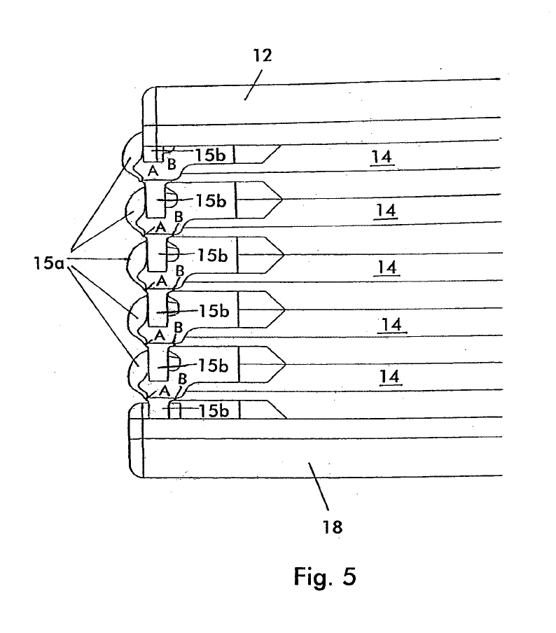

FIG. 4 shows the container 10 in a closed position, where a user is generally denied access to the trays. FIG. 5 illustrates a more detailed view of the container 10 in the closed position. Specifically, FIG. 5 illustrates the interaction between the trays 14 and their associated tabs 15a and ribs 15b with each other and with the covers 12 and 18 in the closed position.

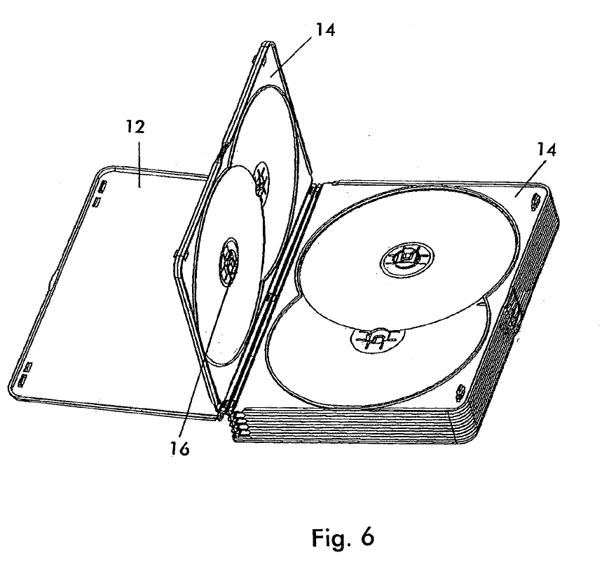

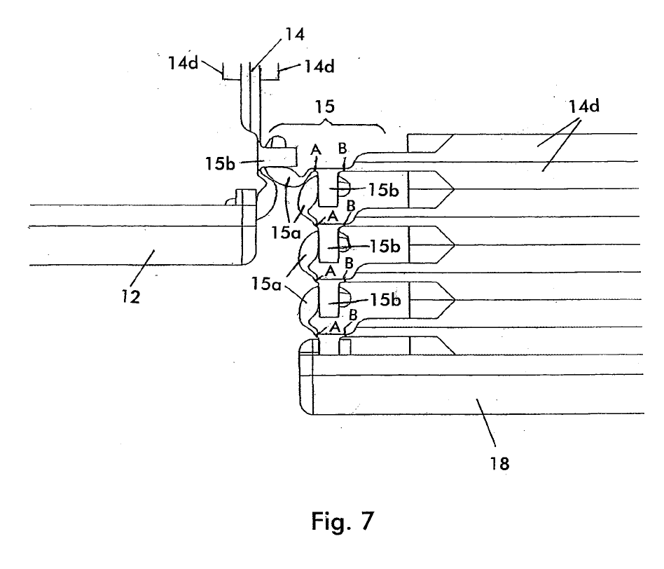

When the container 10 is opened, the trays 14 may be individually accessed as is illustrated in FIG. 6, for example, where the cover 12 and the top tray 14 are separated from the other trays so that a user can access both sides of the top tray. The tray that is exposed in FIG. 6 may be exposed to a user even without the need to separate the covers from the top or bottom trays. That is, each tray may be individually accessed. FIG. 7 illustrates a more detailed view of the container of FIG. 6. As can be seen in FIG. 7, the tabs 15a extend from an inner side of the tray spine 15. Generally, the tabs 15a extend upward in a substantially vertical direction when the container is in a closed position. According to an alternate embodiment, the orientation of the tabs 15a and rib 15b may be reversed. The tabs 15a have a curved shape such that they can be used to connect the trays 14 to each other and to the cover 12 and snap into place. As is noted above, each tray 14 includes a rib 15b that extends rearward from the inner edge of the tray when the tray is in the closed position. This rib 15b includes at least one opening that accommodates a distal end of the tab 15a of the tray spine 15 that is positioned under it to allow for pivotal attachment of the trays together. The tabs 15a snap into the openings in the rib 15b such that the user knows that a connection is made.

As is noted above, the rib 15b is connected to the body of the tray via living hinge B which allows the body of the tray to rotate relative to the rib. Further, as is noted above, the tab 15a is also connected to the rib 15a via a living hinge A, which allows the tab 15a to rotate or pivot relative to the rib 15b and the body of the tray. The two points of articulation provided by the hinges A, B in the tray spine 15 allow for smooth rotation of the trays 14 and covers 12, 18 relative to each other, and thus, allow easy access for a user to the interior of the container 10.

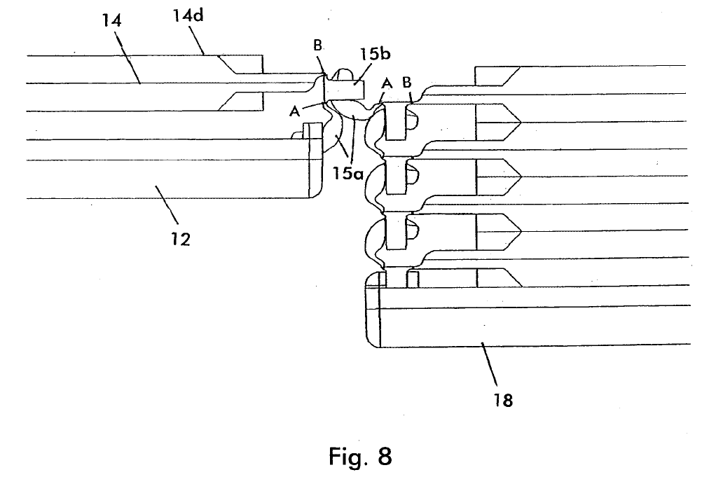

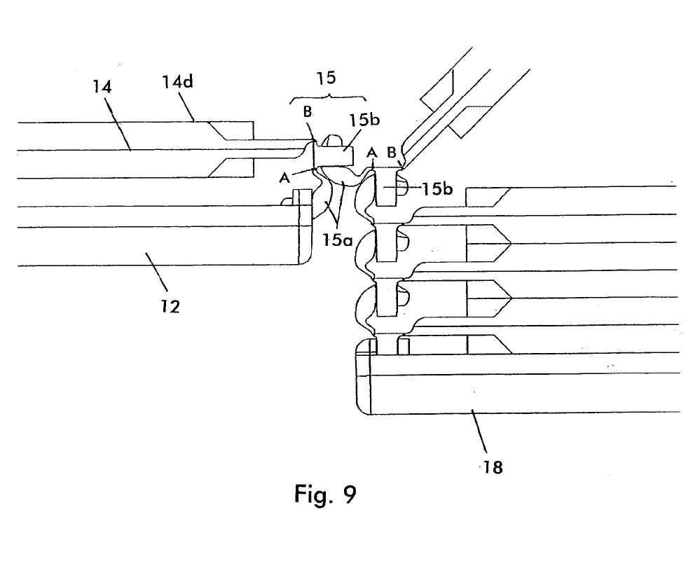

In addition, each tray includes a wall 14d that extends out from the top and bottom surface of each tray around the outer periphery thereof. This wall 14d forms a part of the outer wall of the container 10 when the container is in the closed position. A distal end of the tab 15a of the top tray is received in an opening of the cover 12 as well. The proximal end of each tab 15a includes the living hinge A mentioned above that allows the tab to rotate relative to the rest of the tray 14. As can be seen in FIG. 8, the tab 15a and the living hinges A, B used to connect it to the body of the tray 14 allow the tray to rotate approximately 180 degrees, if desired, to expose additional trays. Since the two living hinges A, B of the tray spine 15 allow for rotation or pivoting at two points, the trays smoothly rotate to allow access to the media stored therein. As can be seen in FIG. 9, once the top tray has been rotated 180 degrees, the other trays may also be rotated as well since they all include similar tray spines 15. FIG. 9 also illustrates how pivoting or rotation occurs between the rib 15b and the body of the tray at the hinge B in the top tray, for example.

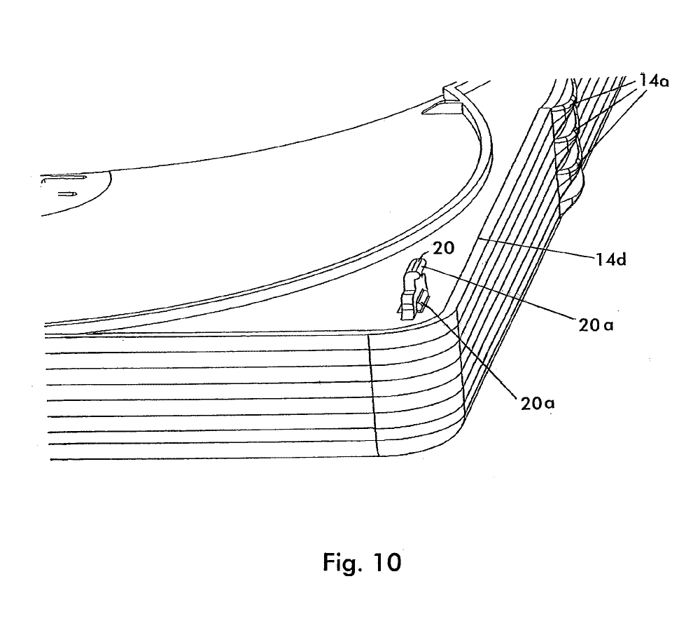

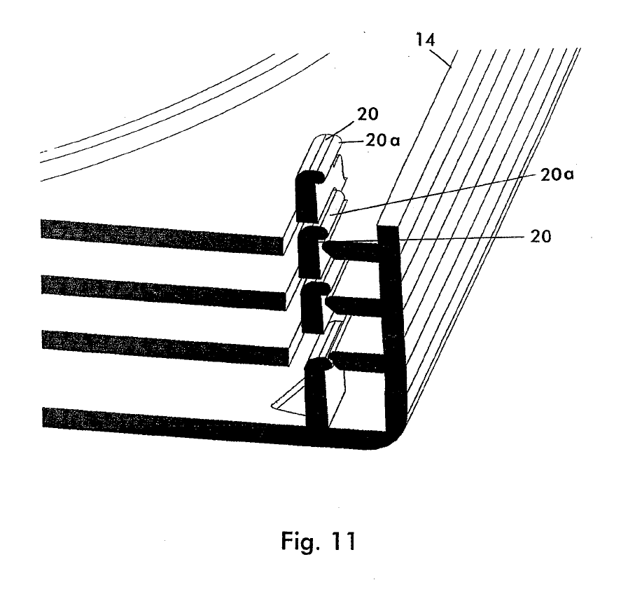

FIG. 10 illustrates a detailed view of the outer side of a tray 14. In a preferred embodiment, a post 20 extends upward from a top surface of the tray 14. A space is provided under the post 20 that accommodates the lip 20a of the post 20 that is positioned on the tray below the space. FIG. 11 illustrates a cross sectional view of the container illustrated in FIG. 10. In this view, it is clear how the post 20 of one tray extends up and through the opening formed under the post 20 of the tray that is above it. The posts 20 help to hold the container 10 closed when the container 10 is in the closed position. That is, when the trays 14 are stacked together, the post 20 of one tray 14 extends upward into the opening of the tray 14 above it. The small laterally extending lip 20a is provided at the distal end of the post 20 and serves to secure one tray 14 to the tray 14 above it. The posts 20 are somewhat flexible such that the lip 20a will release the tray 14 above it when sufficient force is exerted by a user to allow the trays to be separated.

In an alternative embodiment, the posts 20 may extend downward from the bottom surface of the tray and engage openings in the top surface of the tray below them, if desired.

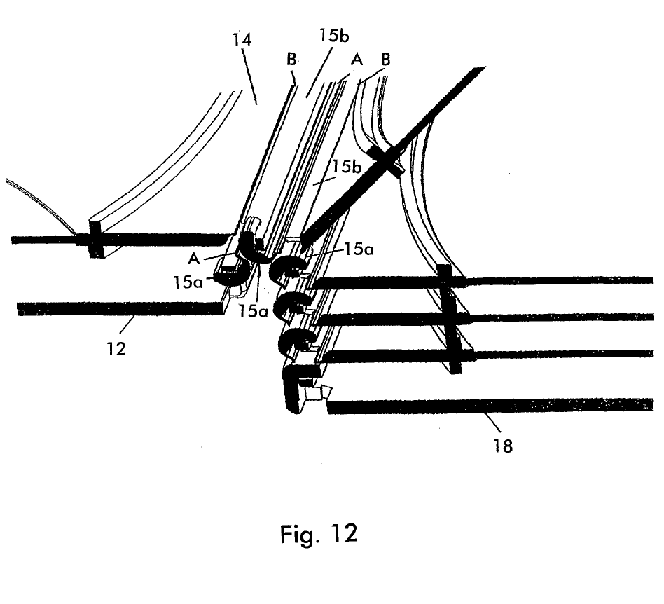

The cross sectional view of FIG. 12 illustrates the interaction between the tabs 15a and the openings formed in the ribs 15b of each tray spine 15 that allows the trays to be securely snap connected to each other while still allowing them to rotate relative to each other.

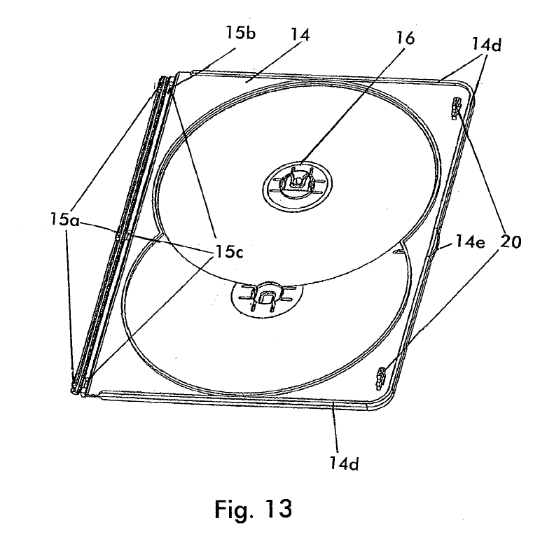

FIG. 13 illustrates a single tray 14. As can be seen in FIG. 13, in a preferred embodiment, each tray 14 includes two posts 20 that extend upward from the top surface of the tray. In addition, each tray 14 preferably includes three tabs 15a, as well, to allow for connection at a top, middle and bottom of the trays 14. Similarly, three openings 15c are provided in the rib 15b to accommodate tabs from other trays 14. Further, each of the trays 14 preferably includes a receptacle 16 positioned on each surface of the tray 14 to accommodate data storage media, such as, optical discs, for example. While the container 10 of the present application has been described as storing optical discs, the trays may include receptacles for any desired data storage medium.

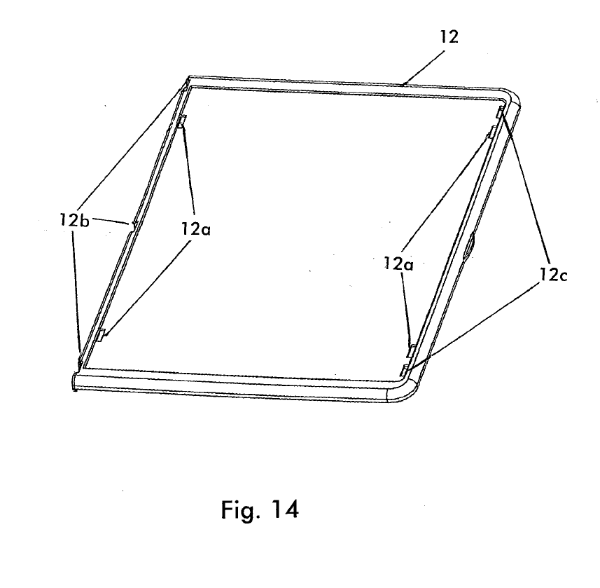

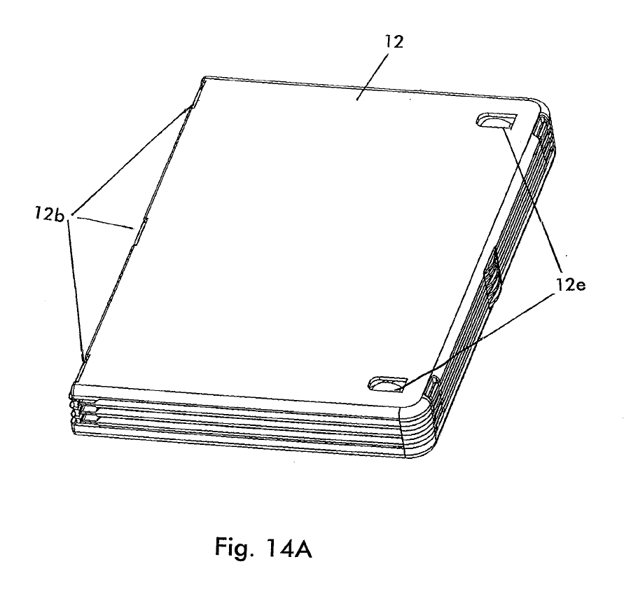

FIG. 14 illustrates an outer surface of the front cover 12. The outer side of the cover 12 includes openings 12a to secure print media, for example, cardboard to the cover 12, as well as openings 12b to accommodate the tabs 15a of the top tray 14 positioned behind the cover 12. The outer side may include openings 12c for the posts 20 of the top tray 14.

FIG. 14A illustrates an alternative embodiment of the cover 12. Specifically, FIG. 14A illustrates the outer surface of the cover 12. In a preferred embodiment, three openings 12b are formed in the front cover to accommodate the tabs 15a of the tray spine 15 of the top tray 14 which is positioned under the cover 12 when the container 10 is in the closed position. In addition, the cover 12 may include clips 12e that are formed on the inner surface thereof and are typically used to hold a booklet or other literature that is commonly provided with pre recorded media.

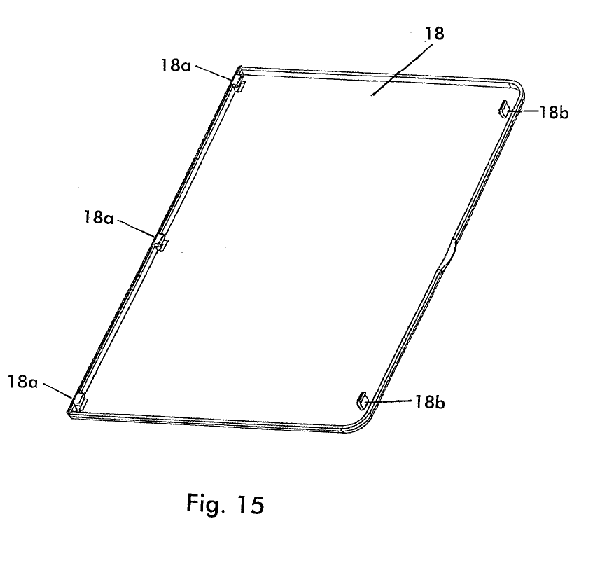

FIG. 15 illustrates the inner surface of the rear cover 18. The rear cover 18 includes tabs 18a, which are similar to the tabs 15a, described above and are used to connect the cover 18 to the tray 14 above it. Further, the posts 18b formed on the other side of the cover 18 extend upward in a manner similar to the posts 20 to keep the container closed.

Each of the trays 14 also includes a tab 14e, as illustrated in FIGS. 10 and 13, for example, that extends out from the outer edge thereof to aid used in grasping a particular tray and to manipulate it as desired.

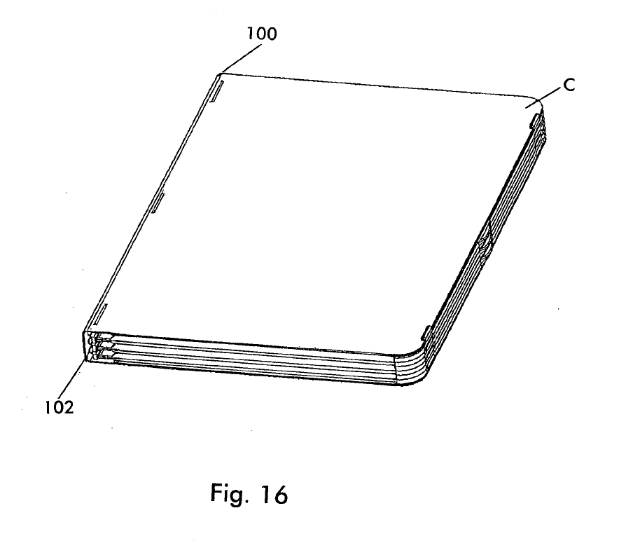

In another embodiment, the cover 12, and/or the rear cover 18 may be made of a cardboard material C, as is illustrated in FIG. 16. The cardboard material allows for the easy addition of writing, graphics or other information, if desired. In this case, the cover C is preferably not connected to the trays 14 via the tray spines 15. Instead, the cover C is preferably glued, or otherwise adhered to the top or bottom tray 14, respectively. In this case, a receptacle 16 is preferably not provided on the surface to which the cover is glued. The cardboard cover C preferably includes a first crease positioned at the inner edge of the tray 14 to which it is attached and a second crease positioned a sufficient distance from the first crease to allow the respective cover to wrap around the tray spines 15 of all of the trays 14 when in the container 10 is in the closed position and to cover the top tray. That is, a single piece of cardboard C may be used to form both covers 12 and 18. FIG. 16 illustrates a container 10 that utilizes a single piece of cardboard C to form the covers 12 and 18. One crease is indicated by reference numeral 100 while the second crease is indicated by reference numeral 102. The cardboard cover C between crease 100 and crease 102 may contain further creases to enable a rounding about the tray spines 15.

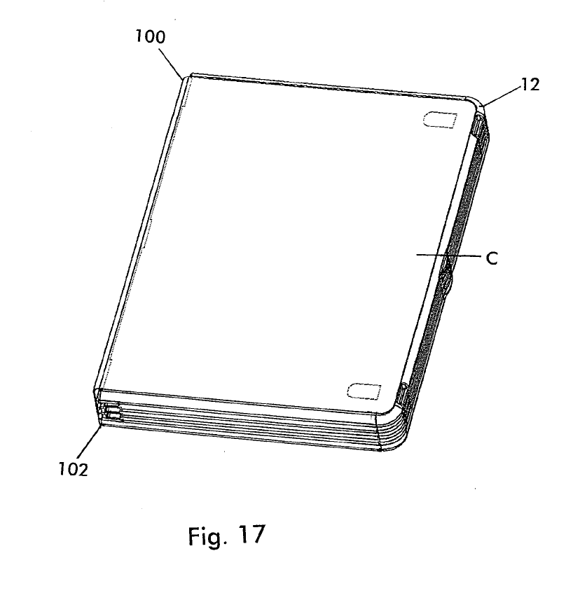

Alternatively, a separate front and rear cardboard cover, or insert, may simply be glued to the outer surface of the top and bottom trays 14, respectively. One or more of these covers may be extended to cover the tray spines 15 of all of the trays 14 when the container is in the closed position, if desired. In another embodiment, illustrated in FIG. 17, a cardboard cover C may be wrapped around the container 10 and cover the plastic covers 12, 18. In a preferred embodiment, the cardboard C is only affixed to the rear cover such that the portion that covers the cover 12 can be peeled back therefrom and writing or other information, such as graphics may be printed on both an outer and inner surface of the cardboard, if desired. Reference numeral 100 refers to one crease while reference numeral 102 refers to the second crease.

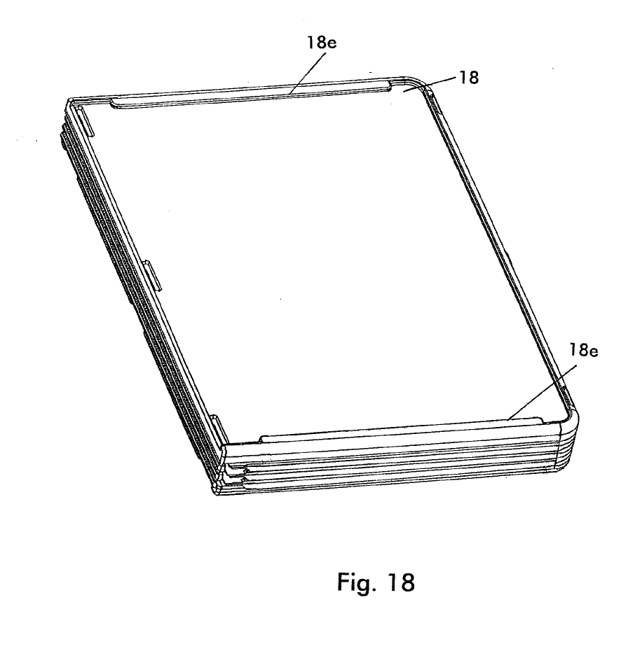

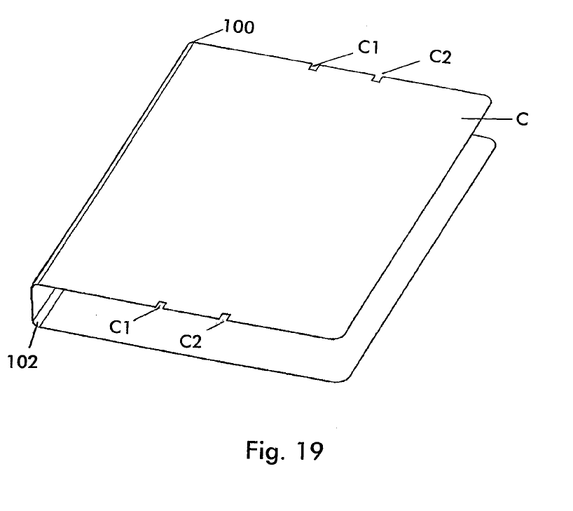

FIG. 18 illustrates the outer surface of the rear cover 18 of a container 10 in accordance with another embodiment of the present application. As can be seen in FIG. 18, the cover 18 may include guide rails 18e that extend out over a portion of the external surface of the cover. If it is desired to cover the cover 18 with cardboard, as mentioned above, for example, the edges of the cardboard may be held in place on the cover 18 under the guide rails 18e. FIG. 19 illustrates an exemplary embodiment of a cardboard cover C that may be provided on the cover 18 of FIG. 18. The cardboard C includes a pair of notches C1, C2 on a top and bottom edge thereof that cooperate with the guide rails 18e of the cover 18 to keep the cardboard cover C in place and attached to the cover 18. The cover C includes the creases 100, 102 that allow the cardboard C to wrap around the tray spines 15 of all of the trays 14 in the container 10 in the manner described above. In this embodiment, it is not necessary to glue the cardboard to the cover 18, however, this may be done if desired.

In the container 10, since each of the trays 14 are rotatable relative to each other, and rotatable relative to the covers 12, 18 as well. Each tray 14 in the container 10 is accessible directly to the user. That is, any individual tray can be accessed even while the covers 12, 18 remain in place to cover the top and bottom trays 14 respectively.

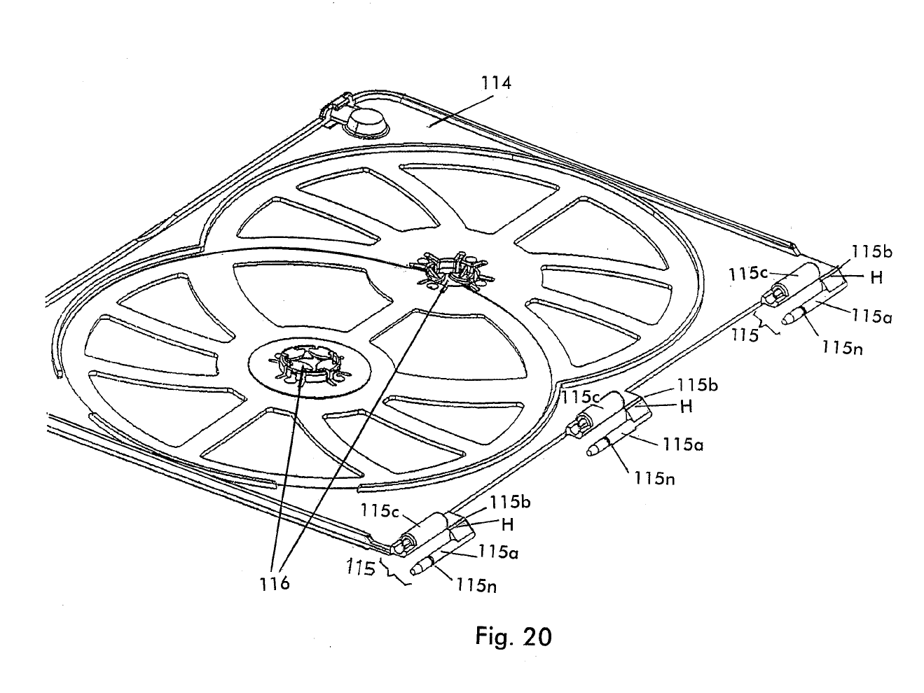

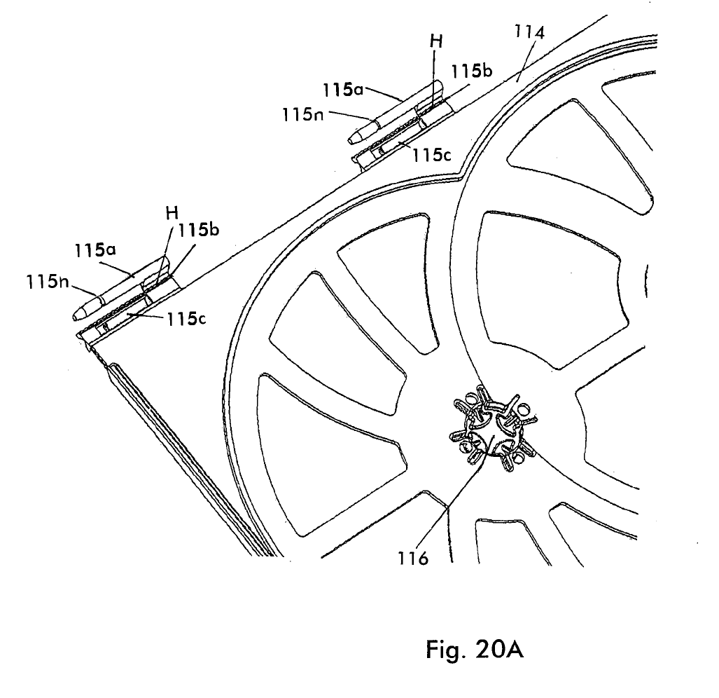

FIG. 20 illustrates an alternative embodiment of a tray 114 for use in the container 10. The tray 114 includes at least one receptacle 116 suitable for holding data storage media, such as an optical disc, for example. In a preferred embodiment, one receptacle 116 is provided on each side of the tray 114. The inner edge of the tray 114 includes a spine portion 115 with at least one elongated protrusion 115a extending therefrom to allow the tray to be connected to others. The elongated protrusion 115a preferably extends in a direction substantially parallel to the inner edge of the tray 114. The protrusion 115a is preferably connected to the rest of the tray 114 via a rib 115b. In a preferred embodiment, the protrusion 115a is connected to the rest of the tray via a living hinge H allowing the elongated protrusion to rotate relative to the rest of the tray. Further, each tray 114 includes a slot 115c structured to accommodate an elongated protrusion 115a of an adjacent tray 114. FIG. 20A illustrates a view of a portion of the tray 114 in FIG. 20 from the other side of the tray. As can be seen in FIGS. 20-20A, for example, the protrusion 115a preferably includes a notch 15n formed near a distal end thereof. This notch 15n cooperates with the slot 15c of an adjacent tray 114 to lock the protrusion into the slot.

While the slot 115c is illustrated as being formed in the rib 115b, it may be positioned virtually anywhere on the inner portion of the tray 114, including the inner edge of the tray. In the present application, the inner portion of the tray refers to the portion of the tray 114 closer to the area around the inner side edge of the tray and includes the inner side edge. In this case, it may not be necessary to include a separate rib at all, provided that the elongated protrusion is connected to the tray via a hinge at least similar to hinge H to allow the protrusion to rotate relative to the tray.

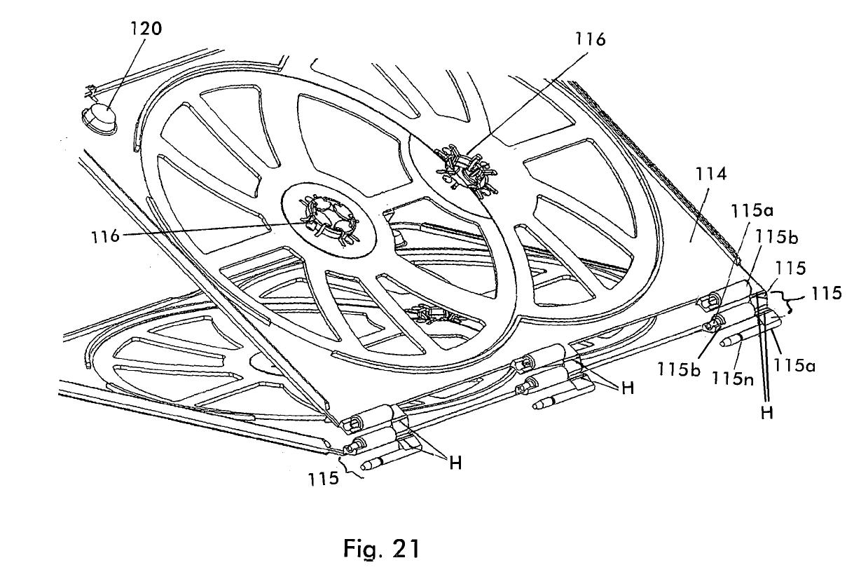

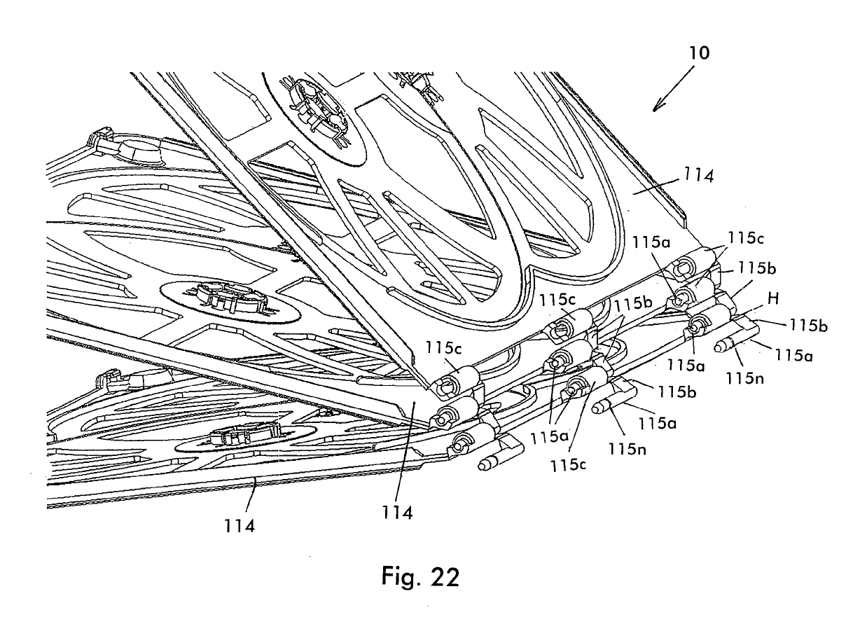

FIG. 21 illustrates how two trays 114 may be joined together. In a preferred embodiment, the elongated protrusions 115a of one tray 114 are received in the slots 115c of an adjacent tray 114. As illustrated, each tray 114 includes three elongated protrusions 115a and three slots 115c, however, any number of protrusions and slots may be utilized. Further, the protrusions 115a and slots 115c are preferably structured such that the protrusions 115a rotate within the slots 115c to aid in rotation of the trays 114 relative to each other. That is, the protrusion 115a in the slot 115c acts as a conventional hinge such that the trays 114 provide for double articulation at the hinge H and slot 115c. FIG. 21 shows the top tray 114 rotated with respect to the lower tray 114. FIG. 22 illustrates three trays 114 rotatably connected to each other, with each of the trays being rotated relative to the others.

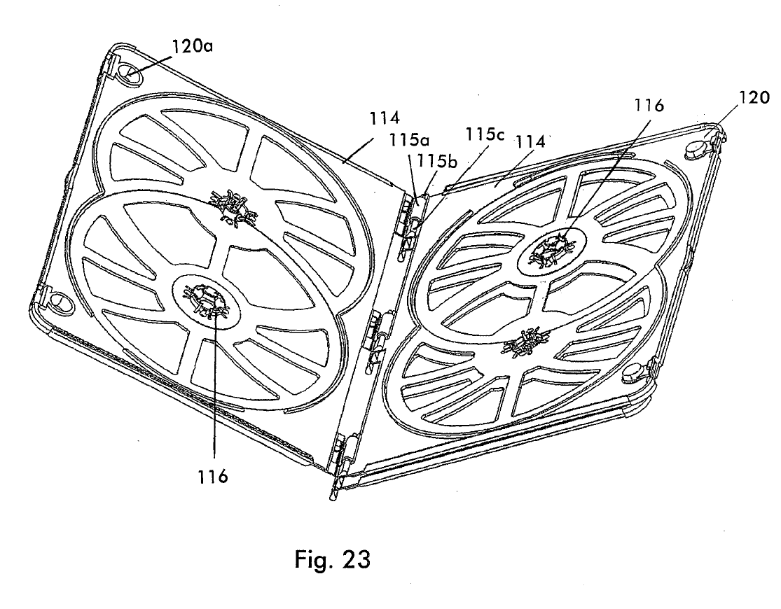

Each tray 114 preferably includes a post 120 (See FIG. 23, for example) extending upward an upper surface of the outer portion of the tray. As can be seen in FIG. 23, for example, the post 120 is preferably formed by a recess 120a formed on a rear surface of the tray opposite the post. In a preferred embodiment, the post 120 of the lower tray 114 is accommodated in the recess 120a of the upper tray 114 to align the trays together. The post 120 is preferably sized to fit in the recess 120a of an adjacent tray such that the trays 114 are aligned with each other. That is, the post 120 assures proper alignment between the trays 114.

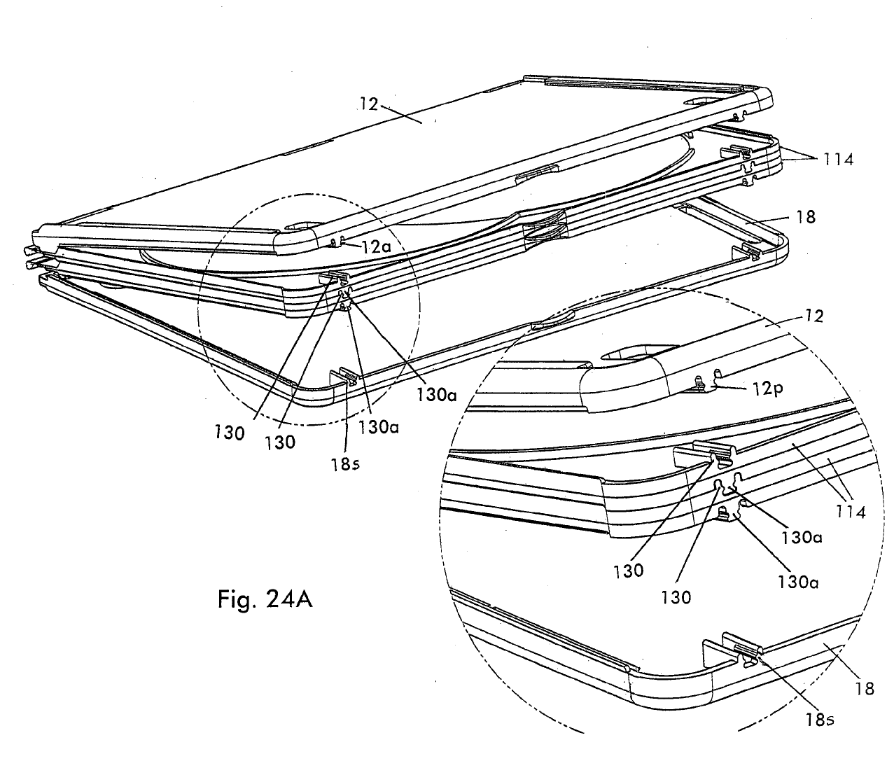

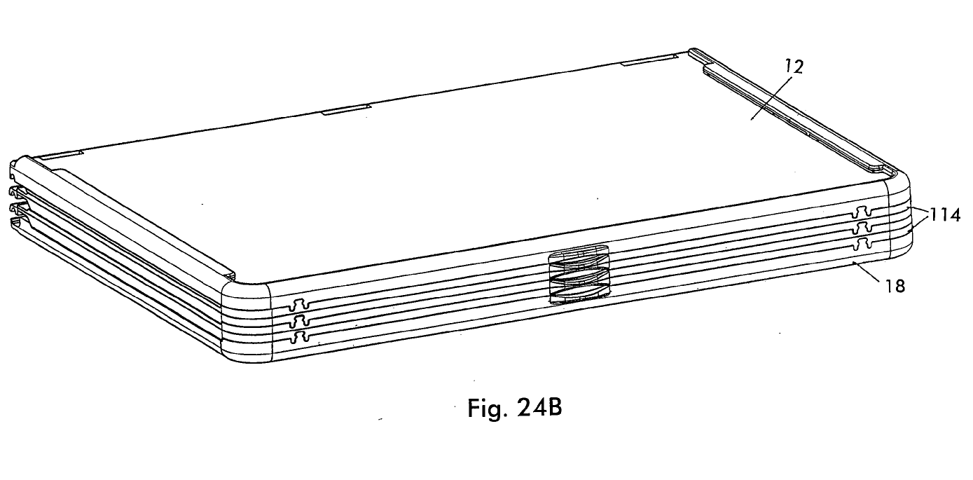

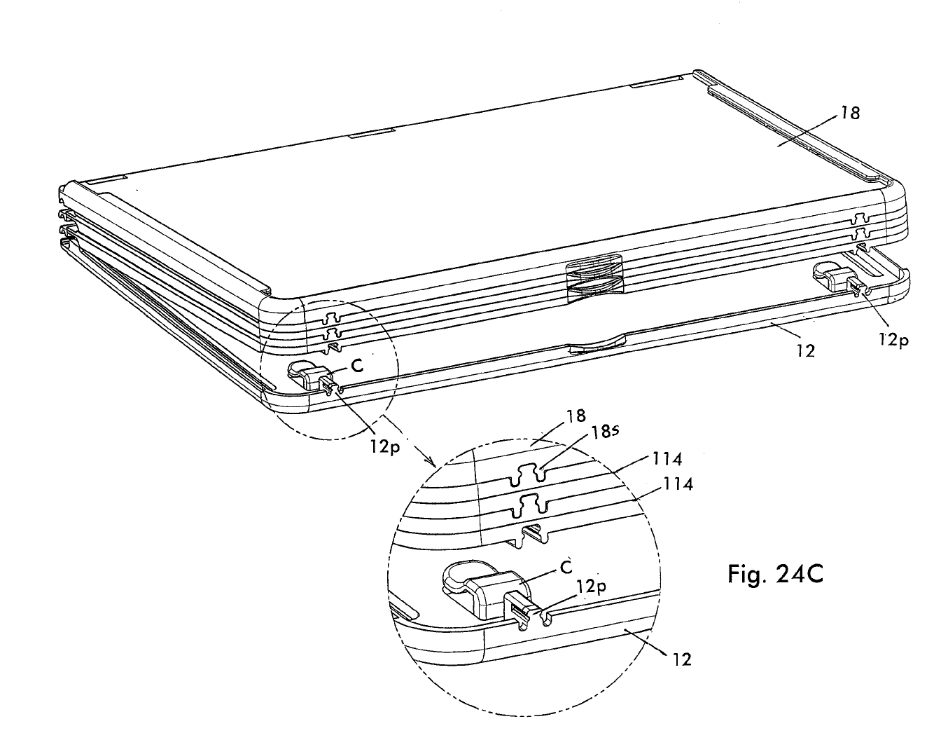

As illustrated in FIG. 24, when the container 10 utilizes the trays 114, the trays are preferably connected the front cover 12 via at least one cover elongated protrusion 12a which is received in a slot 115c of the top tray 114. In this manner, the front cover 12 is rotatable relative to the trays 114. The rear cover 18 preferably includes a cover slot 18c (See FIG. 24) structured to accommodate an elongated protrusion 115a of a bottom tray 114 such that the bottom cover 18 is rotatable relative to the trays 114.

As illustrated in FIGS. 24A, 24B, 24C, each tray 114 also preferably includes a first snap element 130, preferably formed on the outer edge of the top surface of the tray that accommodates a second snap element 130a formed on an outer edge of the bottom surface of an adjacent tray 114. The first and second snap elements 130, 130a cooperate to hold the trays 114 together. The first snap element 130 is preferably formed as a tapered slot formed at the outer edge of the tray. The second snap element 130a is formed as a protrusion extending down from a bottom of the tray 114 at the outer edge thereof and shaped to fit into the tapered slot. The protrusion includes a bulbous tip that snaps into the slot. The rear cover 18 preferably also includes a cover tapered slot 18s that cooperates with the second snap element 130a of the bottom tray 114 to snap the bottom tray to the rear cover. The front cover 112 preferably includes a cover protrusion 12p that extends downward to cooperate with the first snap element 130 of the top tray 114 to snap the front cover to the top tray. FIG. 24B shows the two covers 12, 18 and all of the trays 114 snapped together. FIG. 24C shows a more detailed view of the cover protrusion 12p of the front cover, adjacent to a clip C that may be used to hold literature, for example.

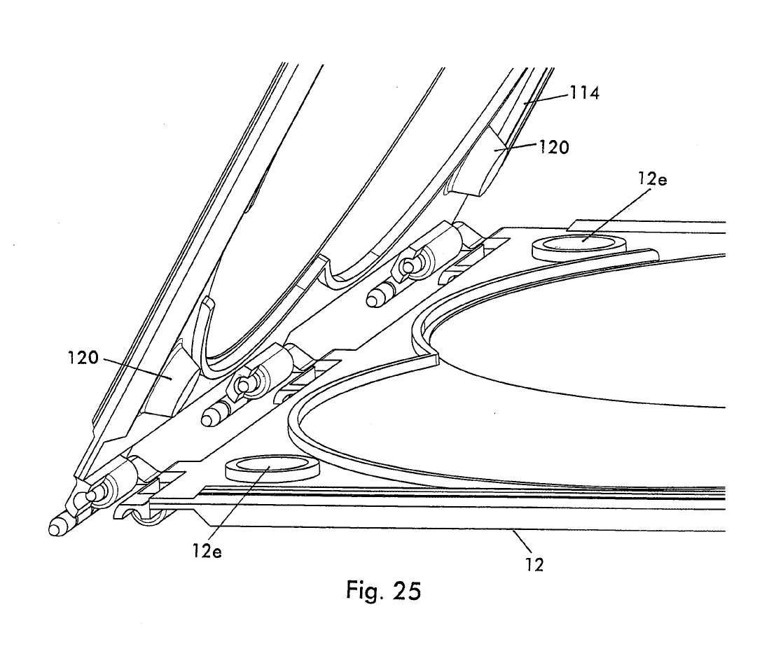

In addition, as can be seen in FIG. 25, for example, the front cover 12 may include a recess 12e, similar to the recess 120a formed in the trays 114 to accommodate the post 120 of the top most tray 114. The rear cover 18 preferably includes a post 120 similar to that of the trays 114 which is received in the recess 120a formed in the bottom most tray to allow for alignment of the trays 114 relative to the covers 12, 18. FIG. 25 specifically illustrates a slightly modified embodiment of the trays 114 in which the posts 120 are positioned in the inner portion of the tray 114. This allows the trays 114 to be brought into proper alignment with each other and with the covers somewhat faster than when the post is positioned on the outer portion of the tray. In addition, if desired, the relative position of the post 120 and the recess 120a may be reversed such that posts extend downward from trays 114 and into recesses 120a formed in trays below them, if desired.

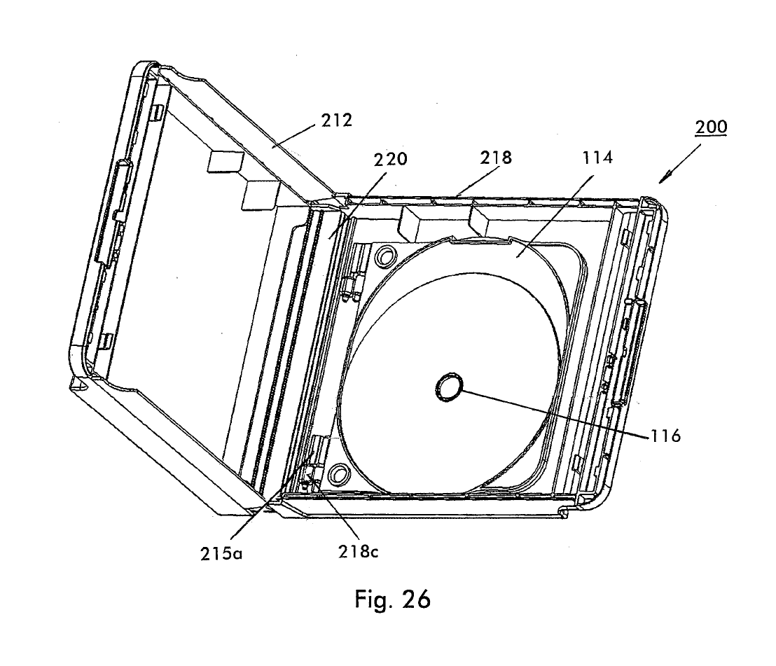

The trays 114 may also be used in conjunction with more conventional containers as well. FIG. 26 illustrates a tray 114 in accordance with an embodiment of the present application that is included in a more conventional container 200. The container 200 preferably includes a front cover 212, a rear cover 218 and a spine 220 rotatably connecting the covers. The covers 212, 218 are rotatable between the illustrated open position of FIG. 26 where access to an interior of the container 200 is provided to a user, and a closed position (not shown) in which the front cover 212, rear cover 218 and spine 220 enclose the interior of the container 200. As illustrated, a tray 114 as described above may be mounted in the container 200.

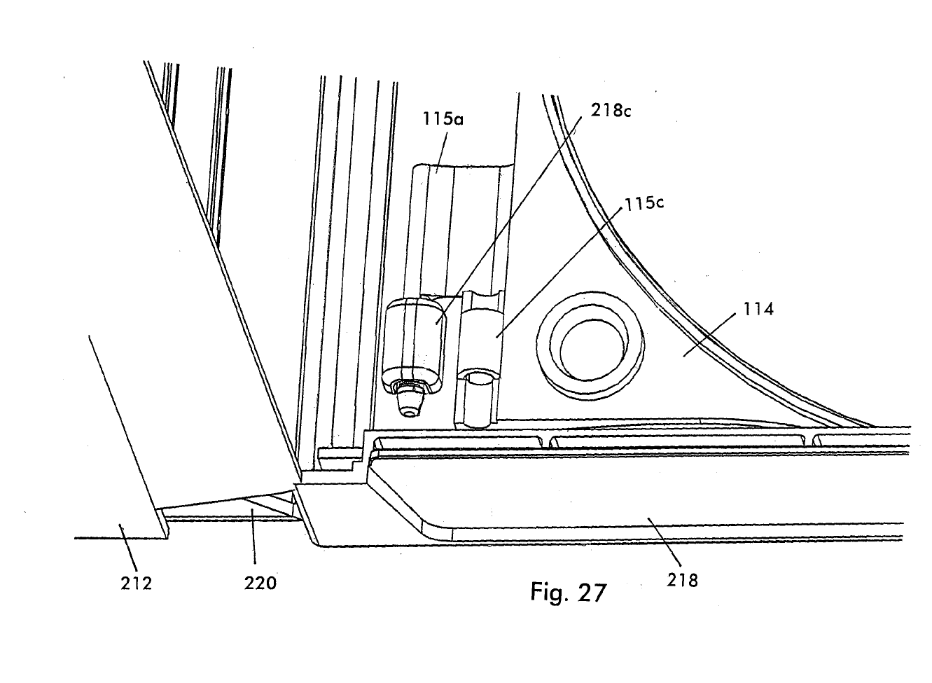

More specifically, as illustrated in FIG. 27, a cover slot 218c is formed on the inner surface of the rear cover 218 and accommodates an elongated protrusion 115a of the tray 114. Thus, the tray 114 is rotatably mounted in the conventional case 200. As illustrated in FIG. 26, when the tray 114 is provided in a conventional container, such as container 200, the tray 114 is preferably only connected to one of the covers, in this case, the rear cover 218. Alternatively, the slot to connect the tray 114 to the container 200 may be provided on the front cover 212, or on the spine 220, if desired.

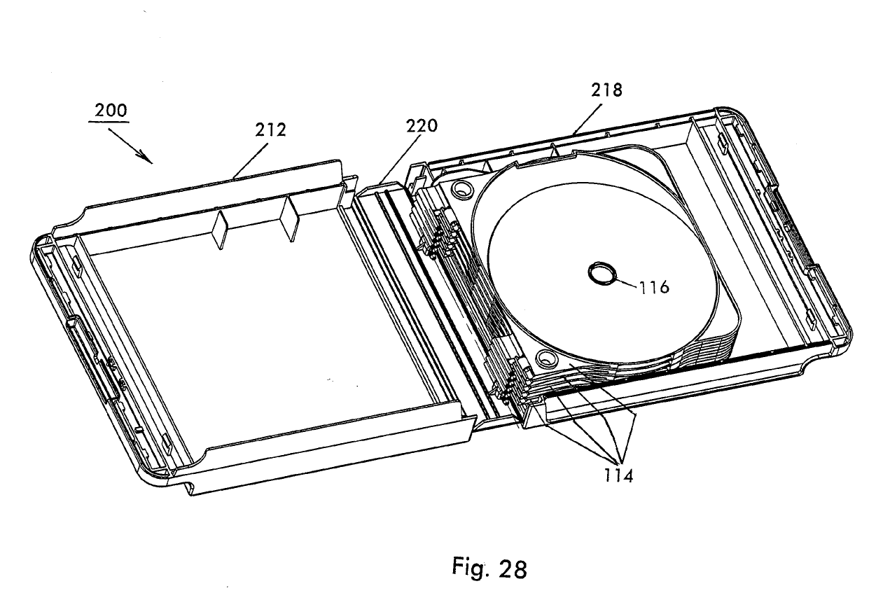

In FIG. 28, multiple trays 114 are mounted in conventional container 200. In this case, the interior of the container 200 must be sufficiently large to accommodate multiple trays 114. As illustrated, only the bottom tray 114 is rotatably connected to the rear cover 218. The other trays 114 are then simply rotatably connected to each other, as described above, to allow access to the data storage media on each of the respective trays. As noted above, the trays 114 may be rotatably connected to the front cover 212 or spine 220, if desired.

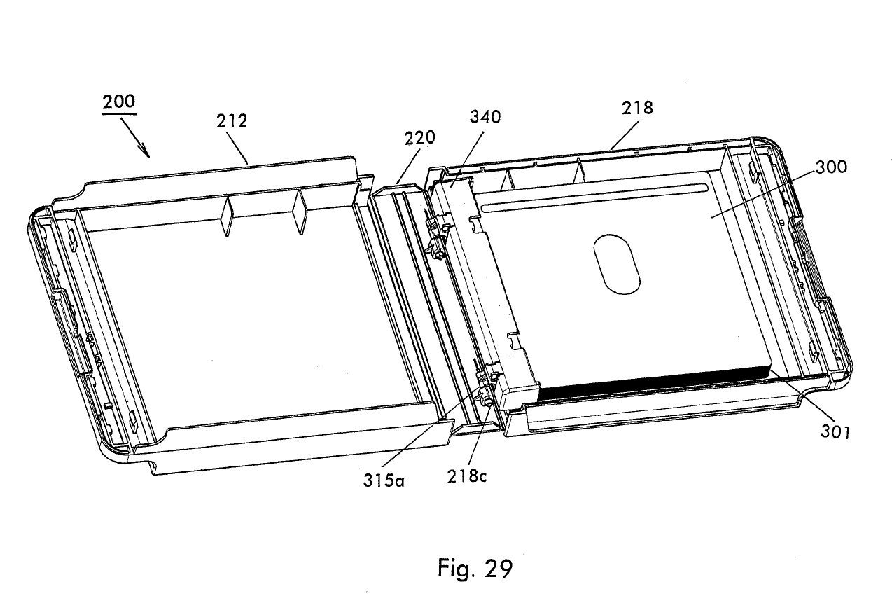

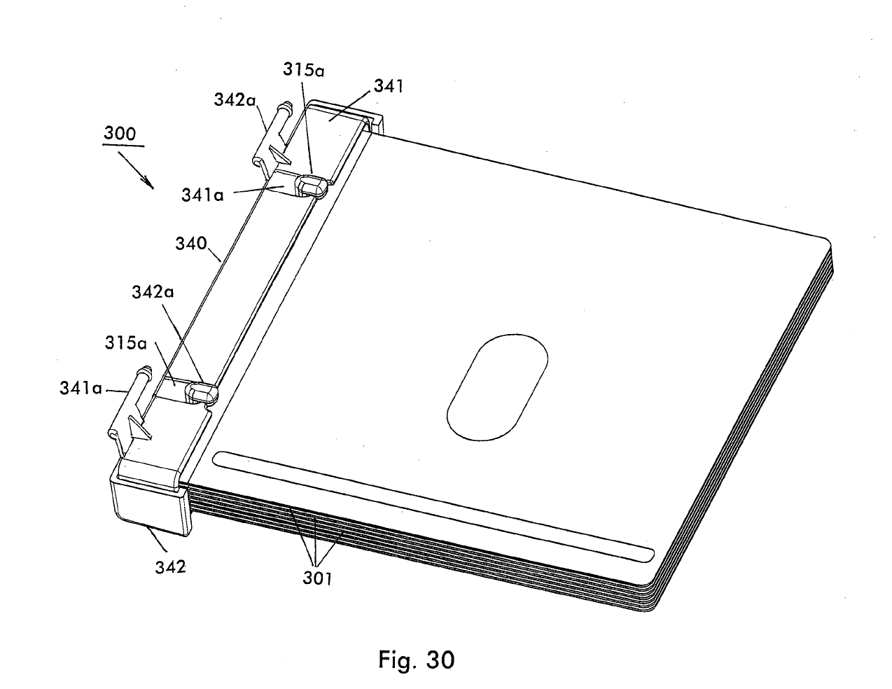

In another embodiment of the present application, a cartridge 300 including multiple sleeves 301 for accommodating optical media, such as CDs, for example, may be provided in conventional container 200, as shown in FIG. 29. The cartridge 300 is preferably rotatably mounted to at least one of the covers 212, 218 using a cartridge elongated protrusion 315a that is accommodated in cover slot 218c, for example. Alternatively, the cartridge 300 may be rotatably mounted in the spine 220, if desired. FIG. 30 illustrates a more detailed view of the cartridge 300 in which the multiple sleeves 301 are held in place via a bracket 340. The bracket 340 is also used to rotatably mount the cartridge 300 in the container 200. The bracket may be connected to either cover 212, 218 or the spine 220 of the container 200.

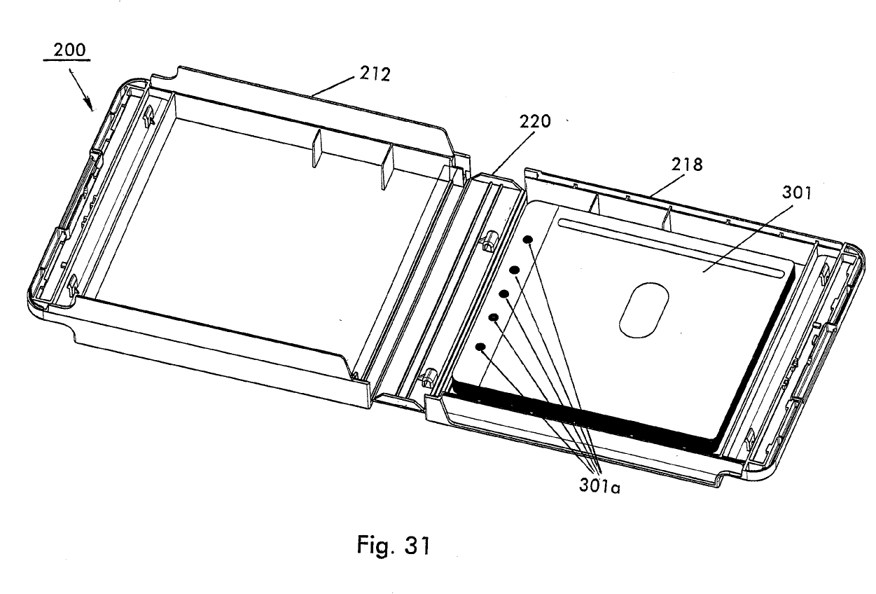

The bracket 340 preferably includes a lower piece 341 including the cartridge elongated protrusion 315a. The cartridge elongate protrusion 315a preferably also includes a notch 315n that is used to lock it into the cover slot 218c, for example. The lower piece 341 preferably snaps into a cover piece 342 such that the sleeves 301 are held in place. As illustrated in FIG. 31, each sleeve 301 includes a plurality of openings 301a through which the pegs 342a (See FIG. 30, for example) extending from an inner surface of the cover piece 342 pass to hold the sleeves 301 in the bracket 340. The pegs 342a snap into the openings 341a formed in the lower piece 341. The sleeves 301 are flexible such that they can be separated and rotated in the cartridge 300 to access individual optical discs, for example.

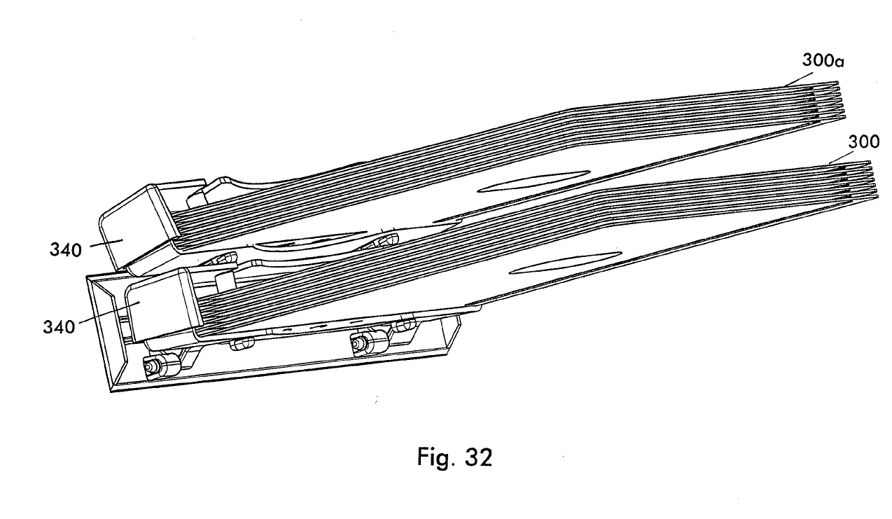

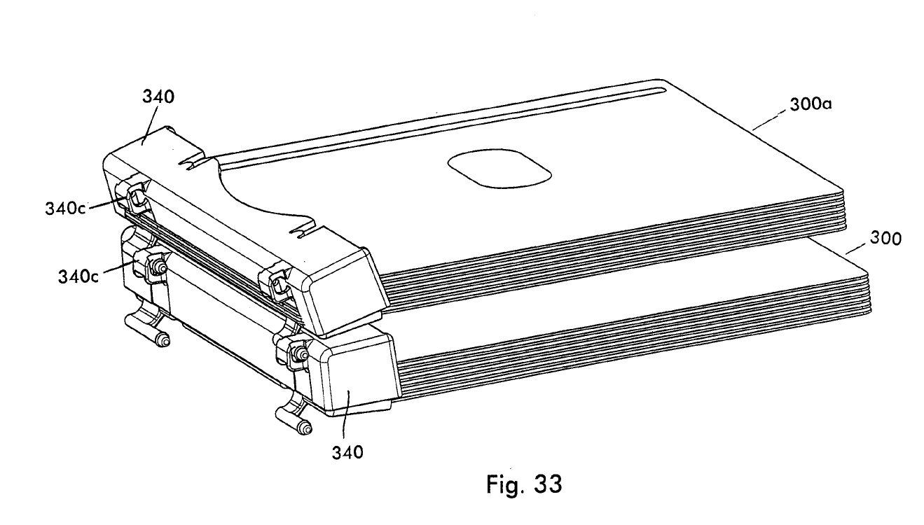

In an alternative embodiment illustrated in FIGS. 32-33, the cartridge 300 may itself be rotatably connected to another cartridge 300a. In this case, the bracket 340 preferably includes bracket slots 340c structured to accommodate the cartridge elongated protrusion 315a of the adjacent cartridge 300a. The protrusion 315a is accommodated in the slot 340c such that the cartridge 300a is rotatable relative to the cartridge 300 and both are rotatable relative to the container 200. FIG. 32 illustrates a cartridge 300 connected to a spine of a container with the adjacent cartridge 300a rotatable connected thereto. FIG. 33 illustrated the cartridge 300 rotatable connected to the adjacent cartridge 300a.

Thus, the trays 114 of the present application can be easily used even with existing media containers to provide additional flexibility. In addition, the cartridge 300 described above can also be implemented in existing media containers to allow for increased flexibility as well.

The container 10 of the present application allows a user even more flexibility since each of the trays 14, 114 can be separately attached to the covers 12, 18 and to each other, the user can add or subtract trays in whatever way they desire. Thus, the container 10 can be adapted to accommodate any desirable number of trays, and thus, any desired number of data storage media. This modular design allows the user to continue to add as many trays as they wish. Further, the user of two living hinges to attach the trays together allows for smooth rotation of the trays in the container, and thus, allows the user to quickly and easily locate and remove individual data storage media wherever they are located in the container. Thus, the container 10 of the present application provides for a low cost, modular, storage system for data storage media with a minimum footprint. Users can easily store and access the data storage media and keep related subject matter, such as media used to store audio book content together in one container.

Although the present invention has been described in relation to particular embodiments thereof, many other variations and modifications and other uses will become apparent to those skilled in the art.

What is claimed is:

1. A container for storing data storage media comprising:
a front cover;
a rear cover; and
a plurality of removable trays operable to support data storage media, each removable tray being rotatably connected to at least one other removable tray, and
the plurality of removable trays being rotatably connected to at least one of the front cover and the rear cover such the data storage media stored on the plurality of removable trays is accessible based on rotation of at least one removable tray.

2. The container of claim 1, wherein the plurality of removable trays is rotatably connected to both the front cover and the rear cover.

3. The container of claim 1, wherein each removable tray of the plurality of removable trays further comprises:
an elongated protrusion extending substantially parallel to an inner edge of the removable tray; and
a slot formed on an inner portion of the removable tray and structured to accommodate the elongated protrusion of an adjacent removable tray such that the removable tray and the adjacent removable tray are rotatable relative to each other.

4. The container of claim 3, wherein the elongated protrusion further comprises a notch formed on a distal end thereof, and the slot is formed to cooperate with the notch such that the elongated protrusion locks into the slot.

5. The container of claim 4, further comprising a rib extending inward from an inner edge of the removable tray, wherein the elongated protrusion is positioned at a distal end of the rib.

6. The container of claim 5, wherein the slot is formed in the rib.

7. The container of claim 6, wherein the elongated protrusion is connected to the rib via a hinge such that the elongated protrusion is rotatable relative to the tray.

8. The container of claim 7, wherein the hinge is a living hinge.

9. The container of claim 8, wherein the elongated protrusion is rotatable in the slot of the adjacent rib to provide a second hinge.

10. The container of claim 2, wherein each removable tray of the plurality of removable trays includes a first receptacle positioned on a first side of the removable tray operable to receive data storage media and a second receptacle positioned on a second side of the removable tray, opposite the first side, operable to receive additional data storage media.

11. The container of claim 10, wherein each tray of the plurality of removable trays further comprises:
a first snap element formed at an outer edge of a top surface of the removable tray; and
a second snap element formed at an outer edge of a bottom surface of the removable tray;
wherein the first snap element of the removable tray cooperates with the second snap element of the adjacent removable tray to snap the removable tray to the adjacent removable tray.

12. The container of claim 11, wherein at least one of the front cover and the rear cover includes a cover snap element operable to cooperate with one of the first and second snap elements of the removable tray.

13. The container of claim 12, wherein the front cover further comprises a cover slot structured to receive an elongated protrusion of a top removable tray such that the front cover and the top removable tray are rotatable relative to each other.

14. The container of claim 13, wherein the rear cover further comprises a cover elongated protrusion structured to be received in a slot of a bottom removable tray such that the bottom removable tray and the rear cover are rotatable relative to each other.

15. The container of claim 14, wherein each removable tray further comprises:
a post extending from upward from an inner portion of the removable tray; and
a recess formed in a second side of the adjacent removable tray opposite the post, and structured to accommodate the post of the adjacent removable tray to align the removable tray with the adjacent removable tray.

16. The container of claim 15, wherein the front cover further comprises a cover connecting recess positioned on an inner portion of the front cover and structured to accommodate a post of a top removable tray to align the top removable tray with the front cover.

17. The container of claim 16, wherein the rear cover further comprises a cover connecting post positioned on an inner portion of the rear cover and structured to be accommodated in the recess of a bottom removable tray to align the bottom removable tray with the rear cover.

18. The container of claim 17, wherein the front cover further comprises a first pair of guide rails extending over a portion of an outer surface of the front cover such that a first small space is provided between the guiderails and the outer surface of the front cover.

19. The container of claim 18, further comprising a front cardboard insert including printed material, wherein a portion of the front cardboard insert is structured to slide between the first pair of guiderails and the outer surface of the front cover.

20. The container of claim 19, wherein the rear cover further comprises a second pair of guide rails extending over a portion of an outer surface of the rear cover such that a second small space is provided between the second pair of guiderails and the outer surface of the rear cover.

21. The container of claim 20, further comprising a rear cardboard insert including printed material, wherein a portion of the rear cardboard insert is structured to slide between the second pair of guiderails and the outer surface of the rear cover.

22. The container of claim 21, further comprising a cardboard spine connecting the front cardboard insert and the second cardboard insert, the cardboard spine including a first crease formed between the front cardboard insert and the cardboard spine and a second crease formed between the cardboard spine and the rear cardboard insert to allow for rotation of the front and rear covers.

23. The container of claim 15, wherein the front cover and rear cover are made of cardboard.

24. The container of claim 23, wherein the rear cover is connected to a bottom removable tray such that the rear cover rotates with the bottom removable tray relative to the plurality of removable trays.

25. The container of claim 24, wherein the front cover is attached to a top removable tray such that the front cover rotates with the top removable tray relative to the plurality of removable trays.

26. The container of claim 25, wherein the front cover and rear cover are connected to each other via a spine portion, and wherein a first crease is formed between the front cover and the spine portion and a second crease is formed between the spine portion and rear cover to allow for rotation of the front and rear covers.

27. The container of claim 23, wherein the front cover and rear cover are connected to each other via a spine portion, and wherein a first crease is formed between the front cover and the spine portion and a second crease is formed between the spine portion and rear cover to allow for rotation of the front and rear covers.

28. The container of claim 1, wherein each removable tray of the plurality of removable trays further comprises:
at least one curved protrusion extending from an inner edge of the removable tray;
a rib portion connected between the curved protrusion and the inner edge of the tray such that the curved protrusion is rotatable relative to the rib portion and the rib portion is rotatable relative to the inner edge of the removable tray; and
a receptacle formed in the rib portion, the receptacle structured to accommodate the curved protrusion of an adjacent removable tray such that the curved protrusion snaps into place in the receptacle and the removable tray and the adjacent removable tray are rotatable relative to one another.

29. The container of claim 28, wherein the rib portion is connected to the curved protrusion via a living hinge.

30. The container of claim 29, wherein the rib portion is connected to the inner edge of the removable tray via a living hinge.

31. The container of claim 30, wherein each removable tray further comprises:
a connecting tab extending from upward from an outer portion of the removable tray; and
a connecting recess formed in the second side of the removable tray opposite the connecting tab, and structured to accommodate the connecting tab of the adjacent removable tray to align the removable tray with the adjacent removable tray.

32. The container of claim 31, wherein the front cover further comprises a cover connecting recess positioned on an outer portion of the front cover and structured to accommodate a connecting tab of a top removable tray to hold the top removable tray to the front cover when in the closed position.

33. The container of claim 32, wherein the rear cover further comprises a cover connecting tab positioned on an outer portion of the rear cover and structured to be accommodated in a connecting recess of a bottom removable tray to hold the bottom removable tray to the rear cover when in the closed position.

34. The container of claim 33, wherein the front cover further comprises a first pair of guide rails extending over a portion of an outer surface of the front cover such that a first small space is provided between the guiderails and the outer surface of the front cover.

35. The container of claim 34, further comprising a front cardboard insert including printed material, wherein a portion of the front cardboard insert is structured to slide between the first pair of guiderails and the outer surface of the front cover.

36. The container of claim 35, wherein the rear cover further comprises a second pair of guide rails extending over a portion of an outer surface of the rear cover such that a second small space is provided between the second pair of guiderails and the outer surface of the rear cover.

37. The container of claim 36, further comprising a rear cardboard insert including printed material, wherein a portion of the rear cardboard insert is structured to slide between the second pair of guiderails and the outer surface of the rear cover.

38. The container of claim 37, further comprising a cardboard spine connecting the front cardboard insert and the second cardboard insert, the cardboard spine including a first crease formed between the front cardboard insert and the cardboard spine and a second crease formed between the cardboard spine and the rear cardboard insert to allow for rotation of the front and rear covers.

39. The container of claim 31, wherein the front cover and rear cover are made of cardboard.

40. The container of claim 39, wherein the rear cover is connected to a bottom removable tray such that the rear cover rotates with the bottom removable tray relative to the plurality of removable trays.

41. The container of claim 40, wherein the front cover is attached to a top removable tray such that the front cover rotates with the top removable tray relative to the plurality of removable trays.

42. The container of claim 41, wherein the front cover and rear cover are connected to each other via a spine portion, and wherein a first crease is formed between the front cover and the spine portion and a second crease is formed between the spine portion and rear cover to allow for rotation of the front and rear covers.

43. The container of claim 42, wherein the front cover and rear cover are connected to each other via a spine portion, and wherein a first crease is formed between the front cover and the spine portion and a second crease is formed between the spine portion and rear cover to allow for rotation of the front and rear covers.

44. A tray for storing data recording media comprising:
a first receptacle positioned on a first side of the tray and operable to receive data storage media;
an elongated protrusion extending substantially parallel to an inner edge of the tray; and
a slot formed in an inner portion of the tray and structured to accommodate an adjacent elongated protrusion of an adjacent tray such that the tray and the adjacent tray are rotatable relative to each other.

45. The tray of claim 44, wherein the elongated protrusion further comprises a notch formed on a distal end thereof, and the slot is formed to cooperate with the slot such that the elongated protrusion locks into the slot.

46. The tray of claim 45, further comprising a rib extending inward from an inner edge of the removable tray, wherein the elongated protrusion is provided on a distal end of the rib.

47. The tray of claim 46, wherein the slot is formed in the rib.

48. The tray of claim 47, wherein the elongated protrusion is connected to the rib via a hinge such that the elongated protrusion is rotatable relative to the rib.

49. The tray of claim 48, wherein the hinge is a living hinge.

50. The tray of claim 49, wherein the elongated protrusion is rotatable in the slot of the adjacent tray to provide a second hinge.

51. The tray of claim 50, further comprising:
a first snap element formed at an outer edge of a top surface of the tray; and
a second snap element formed at an outer edge of a bottom surface of the tray;
wherein the first snap element of the tray cooperates with the second snap element of the adjacent tray to snap the tray to the adjacent tray.

52. The tray of claim 44, wherein the tray further comprises:
a post extending from upward from an inner portion of the tray; and
a recess formed in a second side of the adjacent tray opposite the post, and structured to accommodate the post of the adjacent tray to align the tray with the adjacent tray

53. A container for storing data storage media comprising:
a front cover;
a rear cover;
a spine operable to rotatably connect the front cover and the rear cover such that the front cover and rear cover are operable to rotate between an open position and a closed position; and
a plurality of removable trays operable to support data storage media, the plurality of removable trays positioned in an interior of the container within the front cover, rear cover and spine when the front cover and rear cover are in the closed position,
wherein each tray of the plurality of removable trays further comprises:
a first receptacle positioned on a first side of the tray and operable to receive data storage media;
an elongated protrusion extending substantially parallel to an inner edge of the removable tray; and
a slot formed on an inner portion of the tray and structured to accommodate an adjacent elongated protrusion of an adjacent removable tray such that the removable tray and the adjacent removable tray are rotatable relative to each other.

54. The container of claim 53, wherein the elongated protrusion further comprises a notch formed on a distal end thereof, and the slot is formed to cooperate with the notch such that the elongated protrusion locks into the slot.

55. The container of claim 54, wherein each removable tray further comprises a rib extending inward from an inner edge of the removable tray, wherein the elongated protrusion is provided on a distal end of the rib.

56. The container of claim 55, wherein the slot is formed in the rib.

57. The container of claim 56, wherein the elongated protrusion is connected to the rib via a hinge such that the elongated protrusion is rotatable relative to the rib.

58. The container of claim 57, wherein the hinge is a living hinge.

59. The container of claim 58, wherein the elongated protrusion is rotatable in the slot of the adjacent tray to provide a second hinge.

60. The container of claim 59, wherein at least one of the front cover and the rear cover includes a cover snap element operable to cooperate with one of the first and second snap elements of the removable tray.

61. The container of claim 53, wherein each removable tray further comprises:
a post extending upward from the inner portion of the removable tray; and
a recess formed in a second side of the adjacent removable tray opposite the post, and structured to accommodate the post of the adjacent removable tray to align the removable tray with the adjacent removable tray.

62. A container for storing data storage media comprising:
a front cover;
a rear cover;
a spine operable to rotatably connect the front cover and the rear cover such that the front cover and rear cover are operable to rotate between an open position and a closed position; and
a cartridge operable to support data storage media, wherein the cartridge is rotatably mounted within the container.

63. The container of claim 62, wherein the cartridge further comprises:
a bracket rotatably mounted in the container;
a plurality of flexible storage sleeves retained in the bracket, wherein each storage sleeve is operable to accommodate data storage media.

64. The container of claim 63, wherein the bracket further comprises:
a first part including at least one cartridge elongated protrusion extending substantially parallel to an inner edge of the cartridge and sized to be accommodated in a cover slot formed on an inner surface of one of the front cover, the rear cover and the spine such that the cartridge is rotatable with respect to the one of the front cover, the rear cover and the spine.

65. The container of claim 64, wherein the bracket further comprises a second part, wherein the first part snaps into the second part to retain the plurality of flexible storage sleeves in the bracket.

66. The container of claim 65, wherein the bracket further comprises at least one bracket slot structured to accommodate the elongated cartridge protrusion of an adjacent cartridge such that the adjacent cartridge is rotatably connected to the cartridge.
